(19) United States
(12) Patent Application Publication
(10) Pub. No.: US 2026/0361417 A1
(43) Pub. Date: Nov. 12, 2026

(54) METHOD FOR ESTABLISHING A QUANTUM CHANNEL VIA SATELLITE, SATELLITE FOR ESTABLISHING A QUANTUM CHANNEL, AND METHOD FOR TRANSMITTING A QUANTUM CHANNEL ESTABLISHMENT REQUEST

(71) Applicant: THALES, MEUDON (FR)

(72) Inventor: Jean-Didier GAYRARD, CUGNAUX (FR)

(21) Appl. No.: 18/598,806

(22) Filed: Mar. 7, 2024

(30) Foreign Application Priority Data
Mar. 9, 2023 (FR) 2302173

(51) Int. Cl. H04B 10/70; H04B 10/118

(52) U.S. Cl. CPC H04B 10/70; H04B 10/118

(57) ABSTRACT

A method for quantum channel-based secret key distribution via a satellite (and an associated architecture) wherein the distribution planning is performed in real time by the satellite itself and by the quantum communication ground stations, without the involvement of a mission control centre external to the stations. The satellite is autonomous and manages its own resources. In this architecture, the satellite acquires the information needed to plan its mission autonomously and independently of the ground mission control centre.

### CROSS-REFERENCE TO RELATED APPLICATION

This application claims priority to foreign French patent application No. FR 2302173, filed on Mar. 9, 2023, the disclosure of which is incorporated by reference in its entirety.

### FIELD OF THE INVENTION

The present invention relates to the field of information technology security, and more particularly to the field of quantum channel-based secret key distribution via satellite. This field is also known as satellite-based quantum key distribution (QKD). This field is a sub-field of the field of quantum communication satellites.

### BACKGROUND

Satellite-based quantum communication relies on the transmission of qubits between a satellite, which is generally a transmitter, and one or two quantum communication ground stations, which are generally receivers. A qubit (or qbit) is the quantum information carried by a photon. This information is for example the polarization state of the photon.

Quantum communication consists in establishing a quantum communication channel or quantum channel between a transmitter (the satellite) and a receiver (a ground station). The quantum channel consists of a free-space optical link transmitting a sequence of polarized photons (qubit). The quantum channel may also contain slave optical links: a synchronization and clock link for synchronizing the transmitter and the receiver and for identifying each polarized photon in time, a polarization reference optical link for aligning the polarization reference frames (axes) of the transmitter and the receiver. FIG. 1C schematically illustrates a quantum channel between a satellite and a quantum communication ground station, the link (|Ψ>) being the free-space optical link transmitting qubits.

Quantum key distribution (QKD) is a cryptographic protocol that aims to establish a shared secret between two participants (Alice and Bob) in order to generate a common cryptographic key. This key is then used by the participants to encrypt their communications by way of a symmetric encryption algorithm. Satellite-based quantum key distribution uses one or more quantum channels to transmit random sequences of qubits between the satellite and ground stations.

There are two quantum key distribution protocols: the prepare and measure (P&M) protocol and the quantum entanglement (EB) protocol.

In the prepare and measure (P&M) protocol, the transmitter (Alice or the satellite) prepares a photon by fixing its polarization state and transmits it. The receiver (Bob or the ground station) measures the state of the photon. The transmitter (Alice or the satellite) transmits a random sequence of qubits to the receiver (Bob or the ground station). Due to the protocol, deteriorations in the optical link, parasitic noise and the potential presence of a spy, the sequence detected by Bob is incomplete, contains gaps and contains errors. A reconciliation process allows Alice and Bob to agree on a common sequence that will be used to generate the secret key. FIG. 1A schematically illustrates the implementation of the prepare and measure protocol between the satellite (Alice) and a quantum communication ground station (Bob) connected by a quantum channel (CQ). The exchange of secret keys between the satellite and the ground station requires a single quantum channel. The communication link for reconciliation between the satellite and the ground station is not shown.

In the quantum entanglement (EB) protocol, a third-party transmitter (the satellite) transmits pairs of entangled and polarized photons to two ground stations (Alice and Bob), one photon of the pair of entangled photons to each station. The entanglement property means that Alice and Bob measure the same polarization state on each received photon of a pair of transmitted photons. Random measurement of the pairs of entangled photons carried out by Alice and Bob makes it possible to generate a common random sequence. Degradation of the two optical links between the satellite and the two stations, parasitic noise and the potential presence of a spy alter the random sequence shared by Alice and Bob. A reconciliation process makes it possible to define a common sequence and to generate the secret key. FIG. 1B schematically illustrates the implementation of the entanglement protocol between the quantum communication ground station SCQ1 (Alice) and the ground station SCQ2 (Bob). The satellite is the third-party transmitter of the pairs of entangled photons that it transmits to the ground stations SCQ1 (Alice) and SCQ2 (Bob) via two quantum channels (CQ1 & CQ2). The exchange of secret keys between the two stations requires two quantum channels established with the satellite. The communication link for reconciliation between the two ground stations is not shown. For example, this reconciliation link is a terrestrial link between the two stations or a satellite link via the satellite.

A satellite-based secret key distribution system is a quantum communication infrastructure comprising one or more satellites orbiting the Earth (LEO, MEO, GEO), a set of quantum communication ground stations distributed around the globe and able to establish quantum channels with the one or more satellites in order to exchange random sequences of qubits in the form of polarized photons, and a mission control segment. The control segment includes a mission control centre, a satellite control centre and a network of remote control/telemetry stations (TM/TC). This system thus provides a secret key distribution service, in accordance with a prepare and measure protocol and/or an entanglement protocol.

The problem is that of defining the mission planning of each satellite, that is to say of defining the conditions in which a satellite in visibility of multiple quantum communication ground stations should choose one or two ground stations with which it will establish a quantum channel. At any time, there are multiple quantum communication ground stations in optical visibility of each satellite. A satellite is equipped with one or more optical terminals able to establish a quantum channel with one or more quantum communication ground stations. A quantum channel is a free-space point-to-point optical link, and so an optical terminal of a satellite is able to establish only a single quantum channel with a single ground station.

In addition, quantum optical links are blocked by clouds. Therefore, a quantum communication ground station that is under cloud cover cannot establish a quantum channel with a satellite. Depending on the techniques used to operate the quantum channel, other conditions need to be taken into account: level of atmospheric turbulence above the station, night-time operation only, presence of aerosols, etc.

FIG. 2 schematically illustrates the architecture of a satellite-based secret key distribution system known from the prior art. This system comprises the space segment consisting of the satellites, the user segment combining all of the quantum communication ground stations, and the control segment. The control segment is responsible for managing and controlling the system and its mission. It includes a mission control centre, a satellite control centre and a network of telemetry and remote control stations (TM/TC) with associated links.

The mission control centre develops the satellite mission, that is to say the plan for the use of the satellite resources. A resource is a quantum channel that will be established for a certain time with a ground station. The quantum channel makes it possible to provide the key distribution service.

This planning of the assignment of quantum channels to ground stations is carried out on the basis of:
requests (date and duration) to establish quantum channels with stations in order to provide the key distribution service,
level of service agreements for the stations,
the key distribution matrix, that is to say, for each ground station, the list of other ground stations with which said station exchanges keys,
weather conditions above each station,
the position of the satellite in orbit, making it possible to compute the dates and durations of visibility of each station.

The satellite control centre develops the satellite mission plan based on the plan given by the mission control centre and the requirements specific to the system and to the satellites. The network of TM/TC stations transmits the mission plan to each satellite via a remote control/telemetry channel.

This architecture requires the existence of multiple links between the various elements of the system.

A quantum channel 3 is required between each quantum communication ground station and the satellite in order to exchange secret keys. In addition, a link 1 between the ground station and the mission control centre is required in order to exchange information, for example: the need in terms of the number and duration of establishments of the quantum channel 3, the deadline for the establishment of the quantum channel, the forecasts for the weather conditions above the station. However, this link 1 is critical from the point of view of security. An attack on this link could make it possible to spoof the identity of one or more stations and to be able to establish a quantum channel with a pirate station, in order for example either to obtain secret keys or to inject false keys. Alternatively, an attack could simply cause a denial of service: in the event of loss of this link, the one or more stations affected are no longer able to establish a quantum channel.

Finally, the architecture of FIG. 2 requires the use of a TM/TC link 2 to program or reprogram the mission of the one or more satellites. The performance of the key distribution system is highly dependent on the time taken to transmit, to each satellite, its mission plan developed by the mission control centre planner.

To be optimum, planning should be carried out in quasi-real time in order to take into account changes in cloud cover above the stations. The planner thus has to know the probability of clear conditions or the passage of clouds above the stations in order to develop the best mission plan. This mission plan has to be transmitted to the satellite via the satellite control centre and the network of TM/TC stations quasi-continuously.

The TM/TC link thus has to be permanent in order to reprogram the satellites in real time so as to react to changes in weather conditions. However, apart from the case of satellites in GEO orbit, it is difficult and very expensive to guarantee permanent worldwide coverage of TM/TC signals. Depending on the altitude of the orbits (MEO, LEO), this requires a more or less dense worldwide network of TM/TC stations to be connected to the satellite control centre.

### SUMMARY OF THE INVENTION

The invention aims to overcome certain problems of the prior art. To this end, one subject of the invention is a method for quantum channel-based secret key distribution via a satellite (and an associated architecture) in which the number and the duration of establishment of quantum channels with ground stations is planned in real time by the satellite itself and by the ground stations, without the involvement of a mission control centre external to the ground stations. The satellite is autonomous and manages its own resources. In this architecture, the satellite acquires the information needed to plan its mission autonomously and independently of the ground mission control centre.

By avoiding increasing the number of TM/TC links in order to program or reprogram the satellite mission and links between the ground stations and the mission control centre, the architecture of the invention exhibits improved security, increased simplicity and reduced cost compared to the prior art.

To this end, one subject of the invention is a method for establishing a quantum communication channel via a satellite, the satellite comprising a processing unit storing data associated with a plurality of quantum communication stations comprising a position of said quantum communication ground stations, said method comprising the following steps implemented by the processing unit:
A. Determining a position of the satellite and then determining a quantum channel establishment area of the satellite from said position of the satellite,
B. From said position of said quantum communication ground stations, determining a subset of quantum communication ground stations formed by at least one of the quantum communication ground stations within said quantum channel establishment area,
C. Identifying at least one of the quantum communication ground stations, referred to as visible station:
   contained in said subset,
   that has transmitted a quantum channel establishment request, and
   that is in optical visibility of the satellite,
D. With said data, selecting at least one visible station, referred to as selected station, with which to establish a quantum channel, and then
E. Establishing a quantum channel between said satellite and the selected one or more stations.

According to one embodiment, when there is a number of one or more visible stations greater than a number N≥1 of quantum channels available on the satellite, step D comprises a substep of ranking said quantum channel establishment requests by priority on the basis of information contained in said data, said information being chosen from the following list: a chronological record of the establishments of a quantum channel previously established with the stations, a prior agreement to establish a quantum channel with the stations and instructions issued by the mission control centre, said selection of the selected one or more stations consisting in choosing the one or more N visible stations that has or have transmitted a quantum channel establishment request having a priority ranked among the N first ones. Preferably, said information comprises a duration of optical visibility of the visible stations, computed by the processing unit from said position of said stations, said position of the satellite and a forecast of a trajectory of the satellite.

According to one embodiment, step C comprises:
detecting a laser signal, referred to as optical visibility signal, transmitted by at least one quantum communication ground station contained in said subset, and then
identifying this or these one or more quantum communication ground stations as one or more visible stations.

According to one embodiment, prior to step C, one of the quantum communication ground stations transmits a quantum channel establishment request to a mission control centre, and then said mission control centre transmits said request to the satellite, and said data comprise said request, step C comprising identifying this quantum communication ground station as a visible station when it is in optical visibility of the satellite.

According to one embodiment, the method comprises a subsequent step F consisting in transmitting, to a mission control centre and via a remote control-telemetry channel of the satellite, a signal representative of the number and the durations of establishment of a quantum channel and representative of the quantum communication ground station with which each quantum channel was established.

According to one embodiment, step A is repeated until said subset of quantum communication ground stations is determined in step B, and steps A and B are repeated until the one or more visible stations is or are identified in step C, and steps A, B and C are repeated until the selected one or more stations is or are selected in step D.

According to one embodiment, step E consists in exchanging, on a quantum channel via said satellite, at least one secret key with the selected one or more stations.

Alternatively, according to another embodiment, step E consists in establishing, via said satellite, at least one secret key that is shared by at least two selected stations.

Another subject of the invention is a method for transmitting a quantum channel establishment request, implemented by a processing module of a quantum communication ground station comprising a quantum terminal able to establish a quantum channel with the satellite, said method comprising the following steps:
I. Identifying a need to establish a quantum channel from parameters stored in said processing module, said parameters comprising a prior agreement to establish a quantum channel with said quantum communication ground station, a chronological record of the number and durations of establishment of a quantum channel previously established with the station and a number and durations of establishment of quantum channels allocated to said station,
II. If a need is identified, identifying a satellite having a position in which it is able to establish a quantum channel with said quantum communication ground station, and then determining a forecast of a trajectory of said satellite from said position,
III. From weather data and from said trajectory forecast, determining a time window of optical visibility during which it is possible to establish a quantum channel between said satellite and said station,
IV. Transmitting a quantum channel establishment request, the request being transmitted directly or indirectly to said satellite.

According to one embodiment of the method for transmitting a quantum channel establishment request, the quantum channel establishment request is transmitted directly to said satellite, said request then being a laser signal, referred to as optical visibility signal, transmitted by said station.

According to one embodiment of the method for transmitting a quantum channel establishment request, the weather data comprise local weather readings taken at the quantum communication ground station and local weather forecasts made at the quantum communication ground station for a duration of between 1 minute and minutes.

Another subject of the invention is a satellite able to establish a quantum channel, said satellite comprising:
at least one satellite quantum terminal designed to establish an optical channel with a quantum communication ground station,
an orbit determiner and propagator designed to determine a position of the satellite,
a processing unit storing data associated with a plurality of quantum communication ground stations, said data comprising a position of said stations, said processing unit being connected to the orbit determiner and propagator and designed to implement the following steps:
   A. determining a quantum channel establishment area of the satellite from said position of the satellite as determined by the orbit determiner and propagator,
   B. from said position of said stations, determining a subset of quantum communication ground stations formed by at least one of the quantum communication ground stations within said quantum channel establishment area of the satellite,
   C. Identifying at least one quantum communication ground station, referred to as visible station:
      contained in said subset,
      that has transmitted a quantum channel establishment request, and
      that is in optical visibility of the satellite,
   D. establishing a quantum channel between said satellite and the selected one or more stations by way of a satellite quantum terminal.

According to one embodiment, the satellite comprises an optical detection device connected to the processing unit, and designed such that step C comprises the following substeps:
detecting, by way of said optical detection device, a laser signal, referred to as optical visibility signal, transmitted by at least one quantum communication ground station contained in said subset, and then
identifying this or these one or more quantum communication ground stations as one or more visible stations.

Another subject of the invention is a communication station comprising:
a quantum terminal able to establish a quantum channel with the satellite,
an orbit propagation module designed to determine the positions and the trajectories of the one or more satellites from orbitography data of the one or more satellites,
a processing module designed to receive or determine local weather data and designed to implement the following steps:
   I. Identifying a need to establish a quantum channel from parameters stored in said processing module, said parameters comprising a prior agreement to establish a quantum channel with said station and a chronological record of the number and durations of establishment of a quantum channel with said station,
   II. If a need is identified, identifying a satellite having a position in which it is able to establish a quantum channel with said station, and then determining a forecast of a trajectory of said satellite from said position,
   III. From said weather data and from said trajectory forecast, determining a time window of optical visibility of said satellite during which it is possible to establish a quantum channel between said satellite and said communication station,
   IV. Transmitting a quantum channel establishment request, the request being transmitted directly or indirectly to said satellite.

According to one embodiment, the quantum channel establishment request is transmitted directly to said satellite, said request then being a laser signal, referred to as optical visibility signal, transmitted by said quantum terminal.

### BRIEF DESCRIPTION OF THE DRAWINGS

Other features, details and advantages of the invention will become apparent on reading the description given with reference to the appended drawings, which are given by way of example and in which, respectively:

FIG. 1A shows a schematic view of a device for implementing an optical quantum channel between a satellite and a quantum communication ground station for satellite-based quantum key distribution or exchange (QKD) according to the prior art and implementing a prepare and measure protocol,

FIG. 1B shows a schematic view of a device for implementing two optical quantum channels between a satellite and two quantum communication ground stations for satellite-based quantum key distribution or exchange (QKD) according to the prior art and implementing an entanglement protocol,

FIG. 1C shows a schematic view of the implementation of an optical quantum channel between a satellite and a quantum communication ground station,

FIG. 2 shows a schematic view of a trusted node-based key generation architecture from the prior art,

FIG. 3A shows a schematic view of a secure secret key distribution method according to the invention,

FIG. 3B shows a schematic view of a secret key distribution system according to the invention,

FIG. 3C shows a schematic view of a secret key distribution system according to one embodiment of the invention,

FIG. 3D shows a schematic view of a secret key distribution system according to one embodiment of the invention,

FIG. 4 shows a schematic view of a key distribution method according to one preferred embodiment of the method of the invention,

FIG. 5 shows a schematic view of a method for transmitting a quantum channel establishment request according to the invention.

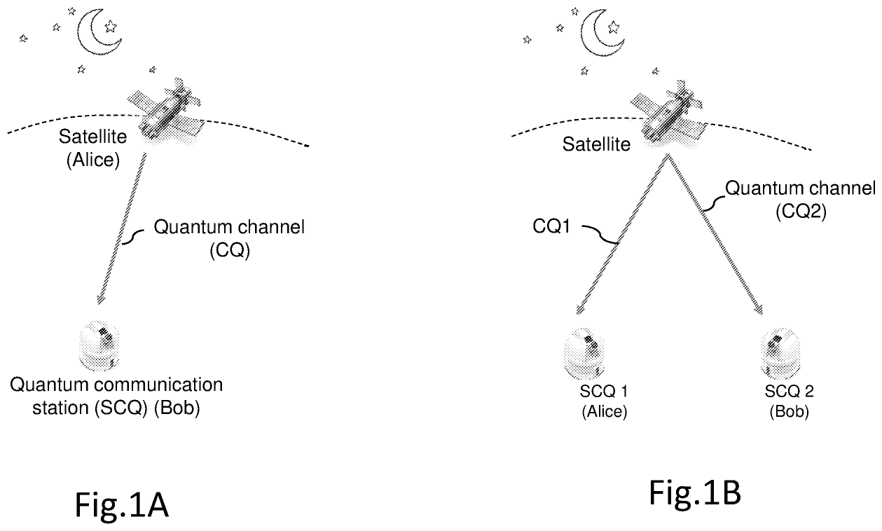

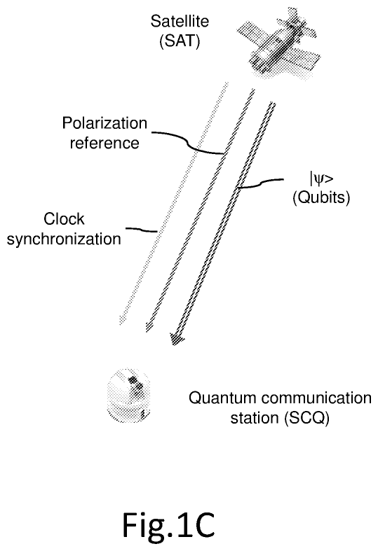

In the figures, unless indicated otherwise, the elements are not to scale and identical references designate identical elements.

### DETAILED DESCRIPTION

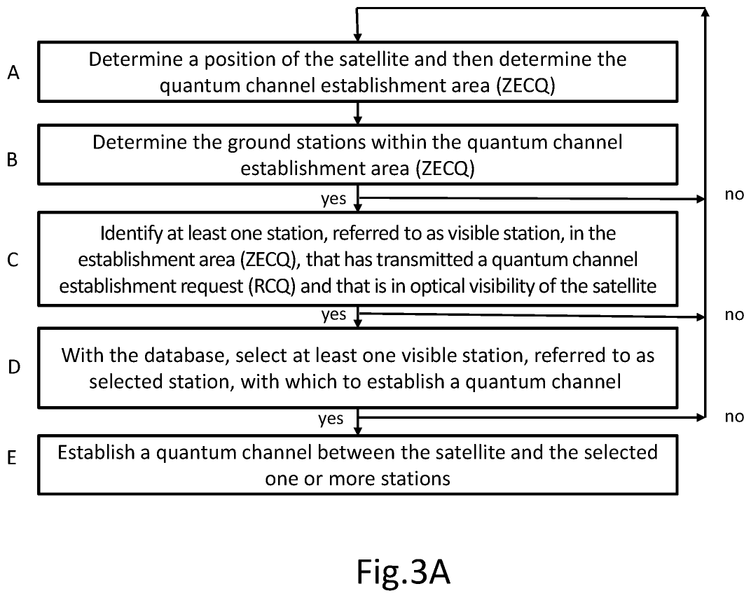

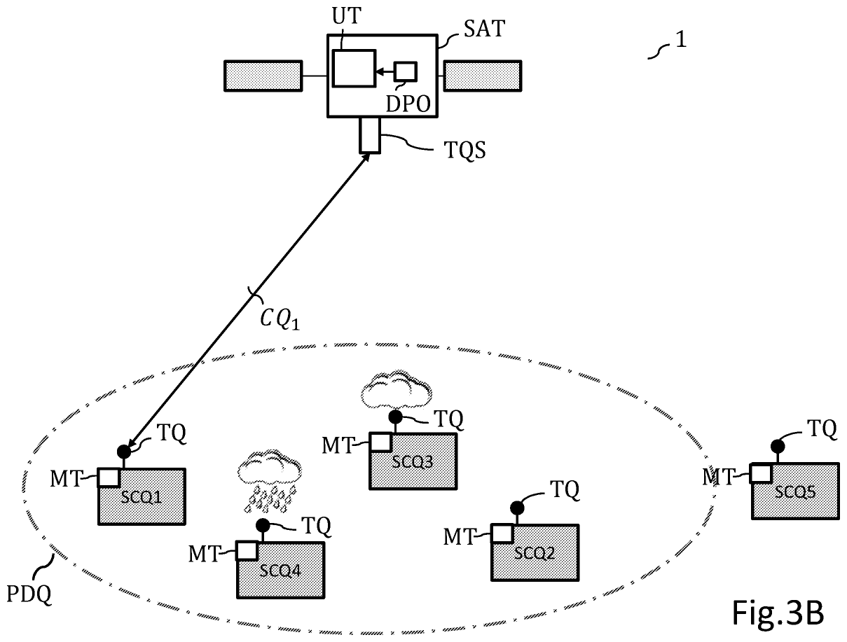

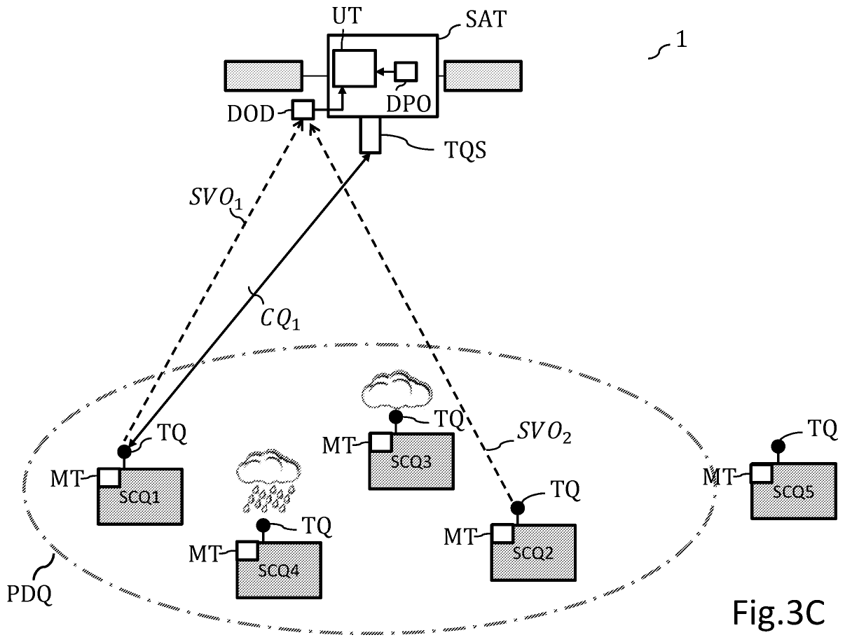

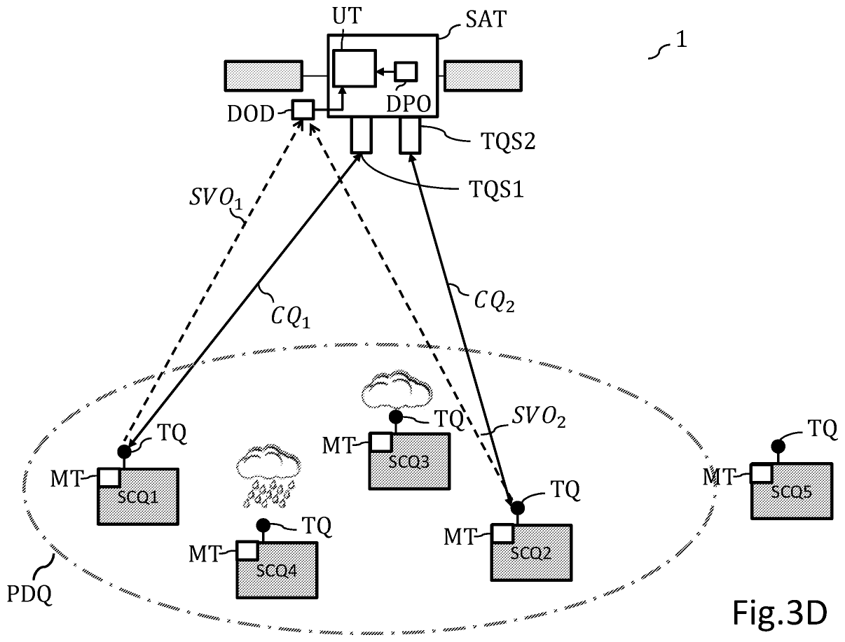

FIG. 3A schematically illustrates a method for quantum channel-based secret key distribution via a satellite Sat according to one embodiment of the invention.

FIG. 3B schematically illustrates a communication system 1 according to the invention, which comprises the satellite Sat and terrestrial quantum communication ground stations SCQ1-SCQ5.

It is important to note that the method of the invention is applicable to establishing a quantum channel for the distribution of secret keys using any protocol known to those skilled in the art. For example, according to one embodiment, the invention is implemented with a prepare and measure (P&M) quantum channel-based secret key exchange protocol, in which the satellite distributes a secret key directly to a single quantum communication ground station. Alternatively, according to another embodiment, the invention is implemented with a quantum channel-based secret key establishment protocol based on quantum entanglement (EB, entanglement-based). In this embodiment, the satellite sends, to two quantum communication ground stations, pairs of entangled photons (one to each station), via a respective quantum channel. These two stations thus share the same secret key.

In the remainder of the description, except when explicitly specified, a description will be given of the method of the invention implemented with a prepare and measure (P&M) quantum channel-based secret key exchange protocol in order to simplify the description of the invention. However, those skilled in the art will understand that the method of the invention (and the satellite designed to implement this method) may be carried over more generally to any channel distribution protocol known to those skilled in the art.

The quantum communication ground stations SCQ1-SCQ5 are thus all able to establish a quantum channel with the satellite Sat by way of their quantum terminal TQ. The quantum channel makes it possible to exchange qubits in order for example to exchange secret keys. Alternatively, the quantum terminal TQ makes it possible to establish, via the satellite Sat, at least one secret key that is shared by two quantum communication ground stations, in the form of a pair of entangled photons. The quantum terminal TQ comprises the elements needed to establish a quantum channel in order to exchange secret keys according to a given protocol, such as for example the BB84 protocol (Bennett and Brassard 1984). The terminal TQ comprises a telescope, a system for pointing and tracking the telescope to the telescope of the satellite Sat, a device for transmitting and receiving quantum communication optical signals and a protocol control device for exchanging secret keys.

By way of non-limiting example, FIG. 3B illustrates one embodiment in which the system 1 comprises five quantum communication ground stations SCQ1-SCQ5. Alternatively, according to another embodiment, the system 1 comprises a number of communication stations other than five.

The satellite Sat comprises at least one satellite quantum terminal TQS that comprises the elements needed to establish a quantum channel with a quantum communication ground station. In addition, it comprises a processing unit UT designed to implement the method of FIG. 3A. This processing unit UT stores data associated with the quantum communication ground stations SCQ1-SCQ5, which data comprise notably a geographical position of said stations SCQ1-SCQ5, a chronological record of the number and the duration of establishments of a quantum channel with said stations SCQ1-SCQ5, making it possible to estimate the volume of secret keys received beforehand by the stations, prior level of service agreements for the stations, and possibly specific instructions related to the stations. A “prior level of service agreement for the station” is understood here to mean an agreement that commits the manager of the system 1 to establish quantum channels between the one or more satellites and the station at a predetermined frequency and duration in order to distribute secret keys at a predetermined frequency and/or volume.

In addition, it comprises an orbit determiner and propagator DPO designed to determine a position of the one or more satellites Sat in real time in a predetermined reference system and to predict the future positions of the one or more satellites. For example, the orbit determiner and propagator DPO may comprise a GNSS (global navigation satellite system) receiver for measuring the position of the satellite and a software-based orbit propagator. The orbit propagator is an algorithm that makes it possible to predict the position and future speed of the satellite from a measured initial position.

In a first step A of the method of FIG. 3A, the processing unit UT determines the instantaneous position at T0 of the satellite Sat by way of the orbit determiner and propagator DPO. After having determined this position, the processing unit UT computes a quantum channel establishment area ZECQ from the position of the satellite Sat. The quantum channel establishment area ZECQ is a geographical area on the ground (shown in FIG. 3B) within which it is possible to establish a quantum channel between the satellite Sat and a quantum communication ground station within this area if weather conditions permit. It is therefore the theoretical geographical area where it is possible to establish a quantum channel between the satellite and a quantum communication ground station located in said geographical area. The establishment of the quantum channel makes it possible to exchange secret keys.

In a step B, the processing unit UT determines, from the stored positions of the quantum communication ground stations SCQ1-SCQ5, a subset of stations SCQ1-SCQ4 formed by at least one of the stations within the quantum channel establishment area ZECQ. In the example of FIG. 3B, the quantum communication ground station SCQ5 is therefore not in the subset since it is too far from the satellite Sat and therefore outside the quantum channel establishment area ZECQ.

After this step B, the method comprises a step C that consists in identifying the one or more quantum communication ground stations of the subset-called visible stations-that are in optical visibility of the satellite and that have transmitted a quantum channel establishment request RCQ. Each quantum channel establishment request RCQ is a signal transmitted beforehand by a respective quantum communication ground station, the signal being transmitted directly or indirectly to the satellite Sat.

In the example of FIG. 3B, only the quantum communication ground stations SCQ1 and SCQ2 are visible stations, because the stations SCQ3 and SCQ4 have local weather conditions, at the time T0, that prevent them from establishing optical contact with the satellite Sat. It is therefore impossible to establish a quantum channel with these stations at the time T0, even though they are within the quantum channel establishment area ZECQ.

Preferably, as illustrated in FIG. 3C, the satellite Sat comprises an optical detection device DOD connected to the processing unit UT. In this embodiment, step C then comprises a first substep consisting in detecting, by way of the optical detection device DOD, a laser signal carrying the quantum channel establishment request RCQ signal, referred to as optical visibility laser signal SVO₁, SVO₂, transmitted by the stations SCQ1 and SCQ2. In the embodiment of FIG. 3C, the transmission of the optical visibility laser signal constitutes the quantum channel establishment request RCQ. In a second substep, the processing unit UT identifies the stations SCQ1 and SCQ2 as visible stations based on the optical visibility laser signals SVO₁, SVO₂.

According to a first embodiment, the optical detection device DOD is able to detect and measure the angle of arrival of the optical visibility laser signals SVOi transmitted by the stations SCQi. From the angle of arrival measurements, the geographical positions of the stations in the quantum channel establishment area ZECQ, said geographical positions being stored in the processing unit UT, and the current position of the satellite as provided by the orbit determiner and propagator DPO, the processing unit UT determines the identity of the visible stations.

According to a second embodiment, the optical detection device DOD is able to detect and analyse the signature of the optical visibility laser signals SVOi transmitted by the stations SCQi. The signature of an optical visibility laser signal SVOi is a characteristic of the optical signal specific to the transmitter station. For example, the optical visibility laser signal SVOi is modulated with on-off keying (OOK) modulation by a binary word identifying the station transmitting the laser signal. Other digital information intended for the processing unit UT may also modulate the optical visibility laser signal SVO. From the geographical positions of the stations in the quantum channel establishment area ZECQ that are stored in the processing unit UT and the station identifier words demodulated by the optical detection device DOD, the processing unit UT determines the identity of the visible stations.

Other embodiments of step C are of course possible.

Preferably, in the embodiment of FIG. 3C, each optical visibility laser signal SVO is transmitted by the system for pointing and tracking the telescope of the quantum terminal TQ of the respective quantum communication ground station. Indeed, the pointing and tracking system makes it possible to establish and maintain optical contact through the transmission of laser beacons. Optical contact is needed to establish the quantum channel between the quantum communication ground station SCQ and the satellite Sat. Pooling the elements of the terminal TQ therefore makes it possible to simplify the architecture of the system 1.

Alternatively, according to another embodiment compatible with the embodiment of FIG. 3C, one of the quantum communication ground stations transmits a quantum channel establishment request indirectly via the mission control centre prior to step C. The quantum channel establishment request, which is received by the mission control centre, is transmitted to the satellite by the satellite control centre through the network of TM/TC stations. In this embodiment, the data stored in the processing unit UT comprise this request and the information concerning the station that transmitted it. Step C then comprises identifying this communication station as a visible station when it is in optical visibility of the satellite. According to one embodiment, the request is transmitted from the mission control centre to the satellite via a remote control-telemetry channel of the satellite. This makes it possible to simplify the architecture of the system 1 by pooling pre-existing channels.

After having identified the visible stations, the method comprises a step D that consists in choosing, among the visible stations—that is to say the stations with which it is possible to establish a quantum channel at T0 and that have requested the establishment of the quantum channel-the one or more stations with which a quantum channel will actually be established.

When there is a number of visible stations greater than a number N≥1 of quantum channels that the satellite Sat is able to establish, step D comprises a substep of ranking the quantum channel establishment requests RCQ by priority on the basis of information contained in the data. This information is chosen from the following list: a chronological record of the number and the duration of establishments of quantum channels with the visible stations, prior level of service agreements for the visible stations and specific instructions related to the visible stations, transmitted by the mission control centre via the network of TM/TC stations. The selection of the one or more visible stations with which a quantum channel will be established thus consists in choosing the one or more N visible stations that have transmitted a quantum channel establishment request (RCQ) having a priority ranked among the N first ones.

For example, the processing unit UT compares the number and the durations of establishment of quantum channels from the chronological record with the frequency and the duration of establishment of quantum channels predetermined in the prior level of service agreement. A station exhibiting a deficit in terms of the number and the duration of establishment of quantum channels greater than that of another station will thus be ranked with a higher priority.

A specific instruction transmitted to the processing unit UT of the satellite by the mission control centre is for example an order to deny service to a given station following the possible existence of a security flaw in said station or following a failure of the manager of a quantum communication ground station to pay the manager of the satellite system 1. Step D will then consist in not selecting this station.

Preferably, the substep of ranking the quantum channel establishment requests by priority is also based on the duration of optical visibility of the visible stations. This duration of optical visibility is computed by the processing unit UT without considering the weather, from the position of the quantum communication ground stations, the position of the satellite at the time T0 and the forecast of the trajectory of the satellite, given by the orbit determiner and propagator DPO. For example, when the processing unit UT computes that a duration of optical visibility of a visible station is insufficient to establish a quantum channel for a duration sufficient to provide a satisfactory quantum key distribution service, the processing unit UT will not select this station in step D. This case of insufficient duration may occur when the station is on the edge of the quantum channel establishment area ZECQ. By way of non-limiting example, it is considered that a duration of visibility less than 3 min is insufficient to establish a quantum channel.

If there is a number of visible stations equal to a number N≥1 of quantum channels available on the satellite Sat, step D consists for example in selecting all visible stations. Alternatively, it is possible not to select one or more visible stations when the processing unit computes that a duration of optical visibility of these visible stations is insufficient to establish a quantum channel and exchange a satisfactory volume of keys. A “duration of optical visibility” is understood here to mean a time window starting from T0 during which the station under consideration and the satellite are able to establish a quantum channel taking into account only purely geometrical parameters (position of the station, position of the satellite and satellite trajectory forecast) stored in the processing unit UT. Likewise, it is possible not to select one or more visible stations when the processing unit compares the number and the durations of establishment of quantum channels from the chronological record with the frequency and the duration of establishment of quantum channels predetermined in the prior level of service agreement for said stations and deduces that the station obtained a number and the durations of establishment of quantum channels equal to or greater than those provided for in the prior agreement.

In summary, step D is a multi-variable optimization step that aims to best meet the quality of service commitment incumbent on the manager of the satellite system by prioritizing the establishment of quantum channels appropriately.

By way of non-limiting example, in the illustration of FIG. 3C, only the station SCQ1 is selected in step D since there is a single quantum channel CQ1 available in the satellite Sat and the station SCQ1 has transmitted a quantum channel establishment request (RCQ) that the processing unit has ranked with a priority higher than that transmitted by the station SCQ2.

Alternatively, according to another embodiment illustrated in FIG. 3D, there are two quantum channels CQ1, CQ2 available in the satellite Sat. Therefore, the two stations SCQ1 and SCQ2 are selected in step D.

The method of FIG. 3A comprises a final step E consisting in exchanging at least one secret key K1 via the quantum channel CQ₁ established between the satellite Sat and the station SCQ1 selected in step D. This step of exchanging a secret key between the satellite Sat and the station SCQ1 is carried out using any method known to those skilled in the art, such as for example the BB84 prepare and measure protocol. In the more general case of any quantum key distribution protocol, step E consists in establishing, via the satellite Sat, a quantum channel with the selected one or more stations. For example, in the embodiment of FIG. 3D where there are two quantum channels CQ1, CQ2 available in the satellite Sat, the quantum channel establishment protocol may be a protocol based on quantum entanglement. Step E thus consists in establishing, via the satellite Sat, at least one secret key that is shared by the two selected stations S1, S2 in the form of a pair of entangled photons via the quantum channels CQ1, CQ2.

Step F may also consist in exchanging, via the quantum channels CQ1 and CQ2 established between the satellite and the two selected stations SCQ1 and SCQ2, at least one secret key K1 that is shared between the two stations SCQ1 and SCQ2. This step of exchanging a secret key between the two stations SCQ1 and SCQ2 is carried out using any method known to those skilled in the art, such as for example the BBM92 entanglement protocol (Bennett, Brassard and Mermin 1992).

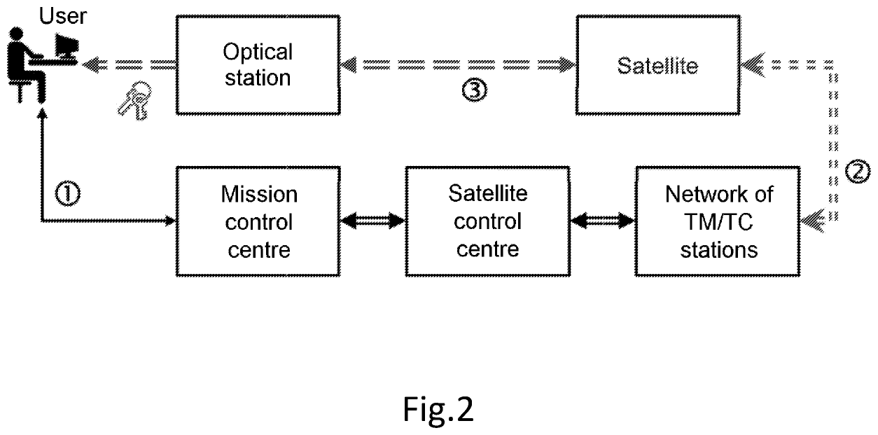

Notably, in the method of FIG. 3A and the associated architecture, planning management is transferred entirely to the satellite Sat and to the quantum communication ground stations via the transmission of quantum channel establishment requests RCQ. The satellite acquires the information needed to plan its mission autonomously and independently of the ground mission control centre, and does so independently of the quantum key distribution protocol. This constitutes a significant change compared to the architecture from the prior art illustrated in FIG. 2, in which the decision-making concerning planning was carried out by the mission control centre. By avoiding increasing the number of TM/TC links in order to program the satellite mission and links between the quantum communication ground stations and the mission control centre, the architecture of the invention exhibits improved security, increased simplicity and reduced cost compared to the prior art.

As illustrated in FIG. 3A, the steps of the method are preferably repeated in a loop until one or more stations is or are selected in step D. More specifically:
step A is repeated in a loop until the subset of quantum communication ground stations is determined in step B,
steps A and B are repeated in a real loop until the one or more visible stations is or are identified in step C,
steps A, B and C are repeated in a loop until the selected one or more stations is or are selected in step D.

After the quantum channel establishment in step E, the processing unit repeats the steps of the method of the invention until one or more stations is or are selected again in step D.

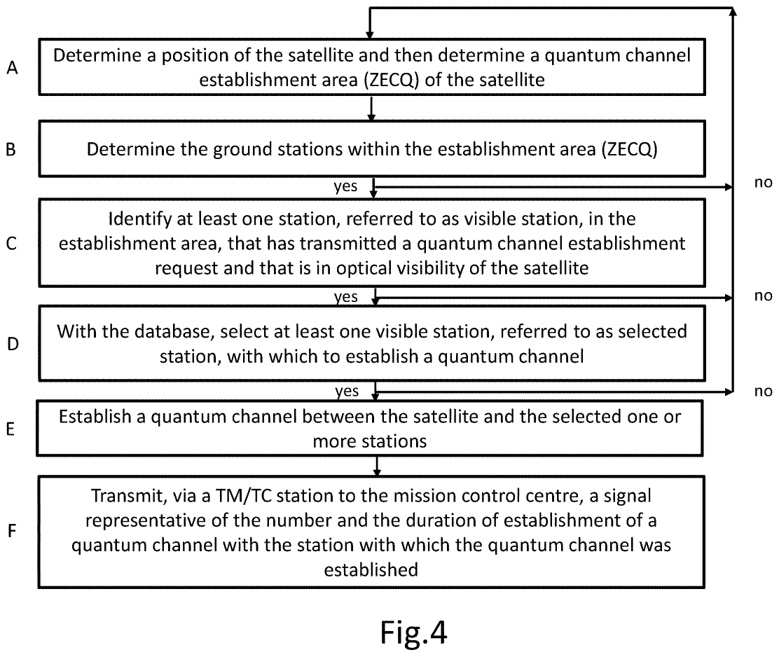

FIG. 4 schematically illustrates the steps of one embodiment of the method of FIG. 3A. In this embodiment, the method comprises a subsequent step F consisting in transmitting, via a TM/TC station to the mission control centre, a signal representative of the number and the duration of establishment of a quantum channel with the ground station with which the quantum channel was established. More generally, the signal is representative of the volume of data exchanged or distributed via a quantum channel and of the communication station with which each channel was established.

The mission control centre is thus able to update its database and adapt the specific instructions related to the stations and transmitted to the satellite. Preferably, this signal is transmitted via a remote control-telemetry (TM/TC) channel of the satellite in order to minimize the number of channels able to be used by the satellite.

As mentioned above, the architecture of the invention makes it possible to transfer planning management to the satellite Sat and to the quantum communication ground stations SCQ1-SCQ5. The invention therefore also relates to a method for transmitting a quantum channel establishment request RCQ.

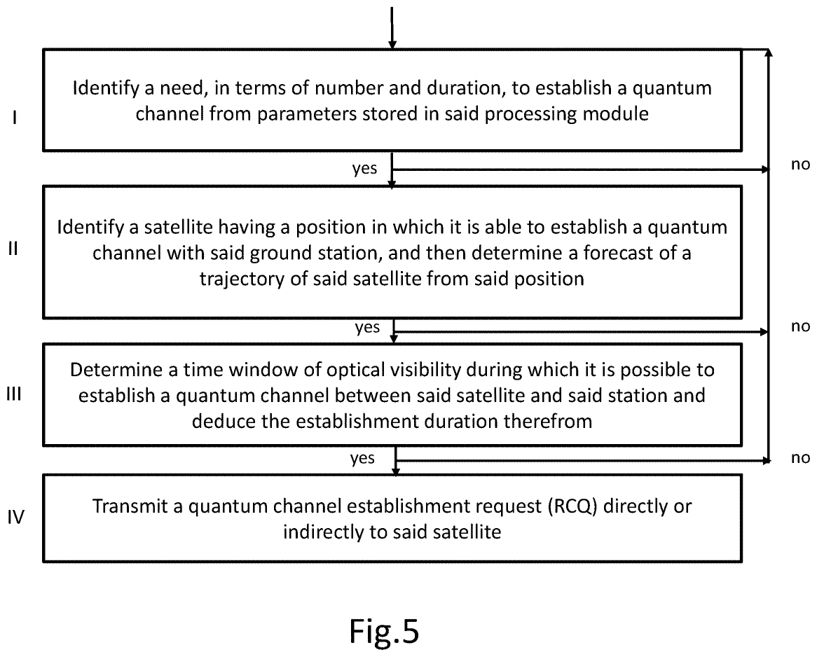

The steps of this method are illustrated in FIG. 5 and are implemented by a processing module MT of each quantum communication ground station SCQ1-SCQ5. The processing module MT is furthermore designed to receive or determine local weather data. These data are weather readings (that is to say physical measurements and instantaneous weather parameters) and weather forecasts. For this purpose, the station comprises for example weather sensors and/or is connected to a weather service provider that is able to transmit local weather data thereto.

The processing module MT of each quantum communication ground station is equipped with an orbit propagation module MPO able to determine the positions or ephemerides of the one or more satellites in the medium term (weeks or months). The orbit propagation module MPO is initialized periodically by orbitography data of the one or more satellites. These orbitography data are provided by the mission control centre via the link connecting the mission control centre and the quantum communication ground stations. Alternatively, these orbitography data may be provided in the form of TLE (two-line elements) by a specialist service provider or by NORAD for example.

In a first step I of the method of FIG. 5, the processing module MT is configured to identify a need, in terms of number and duration, to establish a quantum channel. This identification is performed based on parameters stored in the processing module, which comprise for example: a prior agreement on the frequency and duration of establishment of quantum channels for the station, a stock of secret keys available in the station and a chronological record of the number and the durations of establishment of quantum channels performed by the station. A “stock of available secret keys” is understood to mean the volume of secret keys previously exchanged with the station and that has not yet been used to secure a communication.

For example, when the processing module MT identifies that the stock of secret keys is low or zero, the processing module then identifies a need to establish a quantum channel.

According to another example, a need to establish a quantum channel is identified only when the stock of secret keys is low or zero and the prior agreement on the frequency and duration of establishment of quantum channels provides for a number and durations of establishment of quantum channels that have not been performed to date.

Alternatively, when the processing module MT identifies that the stock of secret keys is low or zero but the prior agreement on the frequency and duration of establishment of quantum channels does not provide for subsequent quantum channel establishment, the processing module MT does not identify a need to establish a quantum channel.

Preferably, this identification is also based on local long-term weather forecast data (for example over one week). For example, when the local long-term weather forecasts predict significant long-term cloud cover, the processing module MT does not identify a need to establish a quantum channel. Indeed, in this case, the probability of managing to establish a quantum channel is low.

If a need is identified in step I, in a second step II, the module MT is configured to identify a satellite Sat having a position in which it is able to establish a quantum channel with the station. For this purpose, the module MT uses the predictions of the satellite positions (ephemerides) that are provided by the orbit propagation module MPO and the geographical position of the station to compute the dates of future periods of satellite visibility, that is to say the dates on which the station will enter the quantum channel establishment area ZECQ of the satellites.

After step II, the method comprises a step III that consists in determining whether there is a time window of optical visibility during which it is possible to establish the quantum channel between the identified satellite and the quantum communication ground station. This determination is performed based on the weather data and based on the forecast of the positions (ephemerides) of the satellite computed in step II. In step III, the relevant weather data taken into account comprise the local weather readings and local weather forecasts for a duration of between 1 minute and 15 minutes, for example. The duration of the time window that is determined in step III depends on multiple parameters including, inter alia, the altitude of the satellite, the minimum elevation of the telescope of the quantum terminal of the station to target the satellite, the duration of the phase of acquisition and mutual pointing of the two telescopes performed by the pointing and tracking system. For example, for an LEO satellite at an altitude of 1262 km (13 orbits per day) and a minimum elevation of 30°, the maximum duration of flight over a station (time window of optical visibility) is 8 minutes. For an MEO satellite at an altitude of 8068 km (5 orbits per day) and a minimum elevation of 30°, the maximum duration reaches 1 hour.

Preferably, the processing module determines the existence of such a time window only when the probability of establishing a quantum channel-taking into account the weather data and the trajectory forecast-is very high. This probability is greater than a probability set out in the prior level of service agreement. This probability may be modified by the mission control centre via the link connecting the station to the mission control centre, on the basis of the management of the network by the system manager.

Finally, the method of FIG. 5 comprises a final step IV consisting in transmitting a quantum channel establishment request (RCQ), the request being transmitted directly or indirectly to the satellite Sat identified in step II.

As mentioned above, according to one embodiment, this request is transmitted indirectly to the satellite Sat via the mission control centre (with the signature of the station that transmitted it in order to be able to identify it). In this embodiment, the request will be stored in the processing unit UT of the satellite before step C of the method of FIG. 3A is implemented.

According to another embodiment, compatible with the previous embodiment mentioned, the quantum channel establishment request (RCQ) is transmitted directly to the satellite Sat, for example in the form of the optical visibility laser signal SVO transmitted by the station.

Compared to the architecture from the prior art, the method of FIG. 5, implemented by the quantum communication ground station according to the invention, has the advantage of not having to acquire data external to the station. The station transmits its quantum channel establishment request (RCQ) only if the conditions for establishing the quantum channel are met in the short term. The station transmits its request if the local forecasts for clear sky in the time window are highly probable (97% or more for example). The satellite allocates a resource to establish a quantum channel with a quantum communication ground station with a very high success rate (99% for example).

The steps of the method of FIG. 5 are preferably repeated in a loop. More specifically, step I is repeated in a loop until a satellite is identified in step II, and steps I and II are repeated in a loop until a time window is identified in step III.

1. A method for establishing a quantum communication channel (CQ₁, CQ₂) via a satellite (Sat), the satellite comprising a processing unit (UT) storing data associated with a plurality of quantum communication ground stations (SCQ1-SCQ5) comprising a position of said quantum communication ground stations (SCQ1-SCQ5), said method comprising the following steps implemented by the processing unit:
A. determining a position of the satellite (Sat) and then determining a quantum channel establishment area (ZECQ) of the satellite from said position of the satellite,
B. from said position of said quantum communication ground stations, determining a subset of quantum communication ground stations (SCQ1-SCQ4) formed by at least one of the quantum communication ground stations within said quantum channel establishment area (ZECQ),
C. identifying at least one of the quantum communication ground stations, referred to as visible station (SCQ1, SCQ2):
contained in said subset,
that has transmitted a quantum channel establishment request (RCQ), and
that is in optical visibility of the satellite,
D. with said data, selecting at least one visible station, referred to as selected station (SCQ1), with which to establish a quantum channel, and then
E. establishing a quantum channel (CQ₁, CQ₂) between said satellite (Sat) and the selected one or more stations.

2. The method according to claim 1, wherein, when there is a number of one or more visible stations greater than a number N≥1 of quantum channels available on the satellite (Sat), step D comprises a substep of ranking said quantum channel establishment requests by priority on the basis of information contained in said data, said information being chosen from the following list: a chronological record of the establishments of a quantum channel previously established with the stations (SCQ1-SCQ5), a prior agreement to establish a quantum channel with the stations (SCQ1-SCQ5) and instructions issued by a mission control centre, said selection of the selected one or more stations consisting in choosing the one or more N visible stations that has or have transmitted a quantum channel establishment request (RCQ) having a priority ranked among the N first ones.

3. The method according to claim 2, wherein said information comprises a duration of optical visibility of the visible stations, computed by the processing unit from said position of said stations, said position of the satellite and a forecast of a trajectory of the satellite.

4. The method according to claim 1, wherein step C comprises:
detecting a laser signal, referred to as optical visibility signal (SVO), transmitted by at least one quantum communication ground station (SCQ1, SCQ2) contained in said subset, and then
identifying this or these one or more quantum communication ground stations as one or more visible stations.

5. The method according to claim 1, wherein, prior to step C, one of the quantum communication ground stations transmits a quantum channel establishment request (RCQ) to a mission control centre, and then said mission control centre transmits said request to the satellite, and wherein said data comprise said request, step C comprising identifying this quantum communication ground station as a visible station when it is in optical visibility of the satellite.

6. The method according to claim 1, comprising a subsequent step F consisting in transmitting, to a mission control centre and via a remote control-telemetry channel of the satellite, a signal representative of the number and the durations of establishment of a quantum channel and representative of the quantum communication ground station with which each quantum channel was established.

7. The method according to claim 1, wherein step A is repeated until said subset of quantum communication ground stations (SCQ1-SCQ4) is determined in step B, and wherein steps A and B are repeated until the one or more visible stations is or are identified in step C, and wherein steps A, B and C are repeated until the selected one or more stations is or are selected in step D.

8. The method according to claim 1, wherein step E consists in exchanging, on a quantum channel (CQ₁, CQ₂) via said satellite (Sat), at least one secret key (K₁, K₂) with the selected one or more stations.

9. The method according to claim 1, wherein step E consists in establishing, via said satellite (Sat), at least one secret key that is shared by at least two selected stations.

10. A method for transmitting a quantum channel establishment request (RCQ), implemented by a processing module (MT) of a quantum communication ground station comprising a quantum terminal (TQ) able to establish a quantum channel with the satellite, said method comprising the following steps:
I. identifying a need to establish a quantum channel from parameters stored in said processing module, said parameters comprising a prior agreement to establish a quantum channel with said quantum communication ground station, a chronological record of the number and durations of establishment of a quantum channel previously established with the station and a number and durations of establishment of quantum channels allocated to said station,
II. if a need is identified, identifying a satellite having a position wherein it is able to establish a quantum channel with said quantum communication ground station, and then determining a forecast of a trajectory of said satellite from said position,
III. from weather data and from said trajectory forecast, determining a time window of optical visibility during which it is possible to establish a quantum channel between said satellite and said station,
IV. transmitting a quantum channel establishment request (RCQ), the request being transmitted directly or indirectly to said satellite.

11. The method according to claim 10, wherein the quantum channel establishment request (RCQ) is transmitted directly to said satellite, said request then being a laser signal, referred to as optical visibility signal (SVO), transmitted by said station.

12. The method according to claim 10, wherein the weather data comprise local weather readings taken at the quantum communication ground station and local weather forecasts made at the quantum communication ground station for a duration of between 1 minute and 15 minutes.

13. A satellite able to establish a quantum channel (C₁, CQ₂), said satellite comprising:
at least one satellite quantum terminal (TQS1, TQS2) designed to establish an optical channel with a quantum communication ground station,
an orbit determiner and propagator (DPO) designed to determine a position of the satellite (Sat),
a processing unit (UT) storing data associated with a plurality of quantum communication ground stations (SCQ1-SCQ5), said data comprising a position of said stations (SCQ1-SCQ5), said processing unit being connected to the orbit determiner and propagator (DPO) and designed to implement the following steps:
A. determining a quantum channel establishment area (ZECQ) of the satellite from said position of the satellite as determined by the orbit determiner and propagator (DPO),
B. from said position of said stations, determining a subset of quantum communication ground stations (SCQ1-SCQ4) formed by at least one of the quantum communication ground stations within said quantum channel establishment area (ZECQ) of the satellite,
C. identifying at least one quantum communication ground station, referred to as visible station (SCQ1, SCQ2):
contained in said subset,
that has transmitted a quantum channel establishment request (RCQ), and
that is in optical visibility of the satellite,
D. from said data, selecting at least one visible station, referred to as selected station (SCQ1), with which to establish a quantum channel, and then
E. establishing a quantum channel (CQ1) between said satellite and the selected one or more stations by way of a satellite quantum terminal (TQS1, TQS2).

14. The satellite according to claim 13, comprising an optical detection device (DOD) connected to the processing unit, and designed such that step C comprises the following substeps:
detecting, by way of said optical detection device (DOD), a laser signal, referred to as optical visibility signal (SVO₁, SVO₂), transmitted by at least one quantum communication ground station (SCQ1, SCQ2) contained in said subset, and then
identifying this or these one or more quantum communication ground stations as one or more visible stations.

15. A communication ground station (SCQ1) comprising:
a quantum terminal (TQ) able to establish a quantum channel with the satellite,
an orbit propagation module (DPO) designed to determine the positions and the trajectories of the one or more satellites from orbitography data of the one or more satellites,
a processing module (MT) designed to receive or determine local weather data and designed to implement the following steps:
I. identifying a need to establish a quantum channel from parameters stored in said processing module, said parameters comprising a prior agreement to establish a quantum channel with said station and a chronological record of the number and durations of establishment of a quantum channel with said station,
II. if a need is identified, identifying a satellite having a position wherein it is able to establish a quantum channel with said station, and then determining a forecast of a trajectory of said satellite from said position,
III. from said weather data and from said trajectory forecast, determining a time window of optical visibility of said satellite during which it is possible to establish a quantum channel between said satellite and said communication station,
IV. transmitting a quantum channel establishment request (RCQ), the request being transmitted directly or indirectly to said satellite.

16. The communication ground station according to claim 15, wherein the quantum channel establishment request (RCQ) is transmitted directly to said satellite, said request then being a laser signal, referred to as optical visibility signal (SVO), transmitted by said quantum terminal (TQ).

17. A communication system comprising a satellite able to establish a quantum channel (CQ₁, CQ₂), said satellite comprising:
at least one satellite quantum terminal (TQS1, TQS2) designed to establish an optical channel with a quantum communication ground station,
an orbit determiner and propagator (DPO) designed to determine a position of the satellite (Sat),
a processing unit (UT) storing data associated with a plurality of quantum communication ground stations (SCQ1-SCQ5), said data comprising a position of said stations (SCQ1-SCQ5), said processing unit being connected to the orbit determiner and propagator (DPO) and designed to implement the following steps:
A. determining a quantum channel establishment area (ZECQ) of the satellite
from said position of the satellite as determined by the orbit determiner and propagator (DPO),
B. from said position of said stations, determining a subset of quantum communication ground stations (SCQ1-SCQ4) formed by at least one of the quantum communication ground stations within said quantum channel establishment area (ZECQ) of the satellite,
C. identifying at least one quantum communication ground station, referred to as visible station (SCQ1, SCQ2):
contained in said subset,
that has transmitted a quantum channel establishment request (RCQ), and
that is in optical visibility of the satellite,
D. from said data, selecting at least one visible station, referred to as selected station (SCQ1), with which to establish a quantum channel, and then
E. establishing a quantum channel (CQ1) between said satellite and the selected one or more stations by way of a satellite quantum terminal (TQS1, TQS2);
the communication system further comprising the quantum communication ground station according to claim 15, designed such that said quantum channel establishment request is transmitted to said satellite, said satellite then being designed to exchange at least one secret key with the quantum communication ground station via the established quantum channel (CQ1).

18. A communication system comprising a satellite able to establish a quantum channel (CQ₁, CQ₂), said satellite comprising:
at least one satellite quantum terminal (TQS1, TQS2) designed to establish an optical channel with a quantum communication ground station,
an orbit determiner and propagator (DPO) designed to determine a position of the satellite (Sat),
a processing unit (UT) storing data associated with a plurality of quantum communication ground stations (SCQ1-SCQ5), said data comprising a position of said stations (SCQ1-SCQ5), said processing unit being connected to the orbit determiner and propagator (DPO) and designed to implement the following steps:
A. determining a quantum channel establishment area (ZECQ) of the satellite from said position of the satellite as determined by the orbit determiner and propagator (DPO),
B. from said position of said stations, determining a subset of quantum communication ground stations (SCQ1-SCQ4) formed by at least one of the quantum communication ground stations within said quantum channel establishment area (ZECQ) of the satellite,
C. identifying at least one quantum communication ground station, referred to as visible station (SCQ1, SCQ2):
contained in said subset,
that has transmitted a quantum channel establishment request (RCQ), and
that is in optical visibility of the satellite,
D. from said data, selecting at least one visible station, referred to as selected station (SCQ1), with which to establish a quantum channel, and then
E. establishing a quantum channel (CQ1) between said satellite and the selected one or more stations by way of a satellite quantum terminal (TQS1, TQS2);
the communication system further comprising at least two quantum communication ground stations (SCQ1, SCQ2) according to claim 15, designed such that each quantum channel establishment request is transmitted to said satellite, said satellite then being designed to generate at least one secret key that is shared by the two quantum communication ground stations (SCQ1, SCQ2) via the quantum channels (CQ₁, CQ₂).
